(19) United States
(12) Patent Application Publication
(10) Pub. No.: US 2011/0098024 A1
(43) Pub. Date: Apr. 28, 2011

(54) MOBILE COMMUNICATION TERMINAL AND METHOD OF AUTOMATICALLY EXECUTING AN APPLICATION IN ACCORDANCE WITH THE CHANGE OF AN AXIS OF A DISPLAY IN THE MOBILE COMMUNICATION TERMINAL

(75) Inventors: Young-Skik Shin, Suwon-si (KR); Kuen Shin, Yongin-si (KR); Chang-Seok Lee, Cheonam-si (KR)

(73) Assignee: Samsung Electronics Co., Ltd., Suwon-si (KR)

(21) Appl. No.: 12/606,744

(22) Filed: Oct. 27, 2009

(30) Foreign Application Priority Data
Oct. 27, 2009 (KR) 10-2008-0105170

(51) Int. Cl. H04M 3/42; H04M 1/00; G06K 9/00

(52) U.S. Cl. 455/414.1; 455/556.1; 382/118

(57) ABSTRACT

A method of automatically executing an application in accordance with the change of an axis of a display in a mobile communication terminal is provided, which includes sensing the change of the axis of the display by using an axis sensor mounted on the display, taking a picture so that a direction indicated by the display can be taken by using a camera mounted on the mobile communication terminal if the display is in a horizontal viewing mode as the result of sensing, performing a face recognition by analyzing an image of the taken picture, and determining whether to execute the application in accordance with the result of face recognition.

### PRIORITY

This application claims priority under 35 U.S.C. §119(a) to an application entitled “Mobile Communication Terminal And Method Of Automatically Executing An Application In Accordance With The Change Of An Axis Of A Display In The Mobile Communication Terminal” filed in the Korean Industrial Property Office on Oct. 27, 2008 and assigned Serial No. 10-2008-0105170, the contents of which are hereby incorporated by reference.

### BACKGROUND OF THE INVENTION

1. Field of the Invention

The present invention relates to a mobile communication terminal, and more particularly to a mobile communication terminal and a method of automatically executing an application in accordance with the change of an axis of a display in the mobile communication terminal.

2. Description of the Related Art

With the development of mobile communication terminals and wireless communication technology, diverse additional functions, such as the ability to view digital broadcasts, image capture using a camera, video telephony, full browsing type Internet access, and the like, have already been developed and commercialized.

Digital Multimedia Broadcasting (DMB) and Digital Video Broadcasting-Handheld (DVB-H) are digital mobile broadcasting standards established to provide digital broadcasts to moving terminals with high receiving rate, and make it possible to realize digital mobile multimedia broadcasting that can provide a user with high picture quality and high sound quality broadcasts any time and in any place even when the user is driving a car or is working.

Also, a user can access and use the Internet in a full browsing manner at any time by using a mobile communication terminal. Accordingly, the user can access the Internet any time and in any place while moving, without being restricted to a stationary location.

In general, a display of a mobile communication terminal is longer in a vertical direction. In the case of performing a phone call or a short message function, which are the basic functions of the mobile communication terminal, a user uses the terminal in a vertical viewing mode for a user to view the display vertically. However, in the case of viewing a digital mobile broadcast such as DMB or DVB-H, using the Internet in a full browsing manner, executing a moving image stored in the mobile communication terminal, or taking a picture using a camera, it is advantageous for the user to view the display of the mobile communication terminal in a horizontal viewing mode by turning the mobile communication terminal in a clockwise or counterclockwise direction (i.e. right or left) by 90°. In this case, the user presses a specified button to execute an application for viewing the display in a horizontal viewing mode, and then turns the mobile communication terminal to the left/right in order to view the display in the horizontal viewing mode.

### SUMMARY OF THE INVENTION

Accordingly, the present invention has been made to solve at least the above-mentioned problems occurring in the prior art, and an object of the present invention is to provide a mobile communication terminal and an application execution method in the mobile communication terminal, which can automatically execute an application for a preset horizontal viewing mode without any separate key input when a display of the mobile communication terminal is shifted to the horizontal viewing mode.

In accordance with an aspect of the present invention, there is provided a method of automatically executing an application in accordance with the change of an axis of a display in a mobile communication terminal, which includes sensing the change of the axis of the display by using an axis sensor mounted on the display; taking a picture so that a direction indicated by the display can be taken by using a camera mounted on the mobile communication terminal if the display is in a horizontal viewing mode as the result of sensing; performing a face recognition by analyzing an image of the taken picture; and determining whether to execute the application in accordance with the result of face recognition.

In accordance with another aspect of the present invention, there is provided a mobile communication terminal for automatically executing an application in accordance with the change of an axis of a display, including the display outputting various types of data generated in the mobile communication terminal; an axis sensor mounted on the display to sense the change of the axis of the display; a camera capturing an image; an image processor performing a face recognition by analyzing image information captured by the camera; and an axis change processor receiving the sensing result from the axis sensor, controlling the camera to take a picture if the display is in a first viewing mode, and determining whether to execute the application in accordance with the result of face recognition through the image processor.

### BRIEF DESCRIPTION OF THE DRAWINGS

The above and other aspects, features and advantages of the present invention will be more apparent from the following detailed description taken in conjunction with the accompanying drawings, in which:

FIG. 1 is a block diagram illustrating the configuration of a mobile communication terminal for executing an application according to an embodiment of the present invention;

FIG. 2 is a diagram illustrating an application execution operation when a mobile communication terminal is shifted to a horizontal viewing mode according to an embodiment of the present invention; and

FIG. 3 is a flowchart explaining an application execution in a mobile communication terminal according to an embodiment of the present invention.

### DETAILED DESCRIPTION OF THE EMBODIMENT

Hereinafter, embodiments of the present invention will be described with reference to the accompanying drawings. In the following description, the same elements will be designated by the same reference numerals although they are shown in different drawings. Further, various specific definitions found in the following description are provided only to help the general understanding of the present invention, and it is apparent to those skilled in the art that the present invention can be implemented without such definitions. Further, in the following description of the present invention, a detailed description of known functions and configurations incorporated herein will be omitted when it may make the subject matter of the present invention rather unclear.

The present invention provides a mobile communication terminal and a method of automatically executing a preset horizontal viewing mode application when a display of the mobile communication terminal is shifted to a horizontal viewing mode, so that the application suitable to the horizontal viewing mode can be executed. For this, an axis sensor is included in the mobile communication terminal to sense the change of an axis of the display, a camera mounted on the front surface of the display starts photographing when the axis is changed (i.e. when the display is shifted to the horizontal viewing mode). The horizontal viewing mode application is executed when a face is recognized in the photographed image.

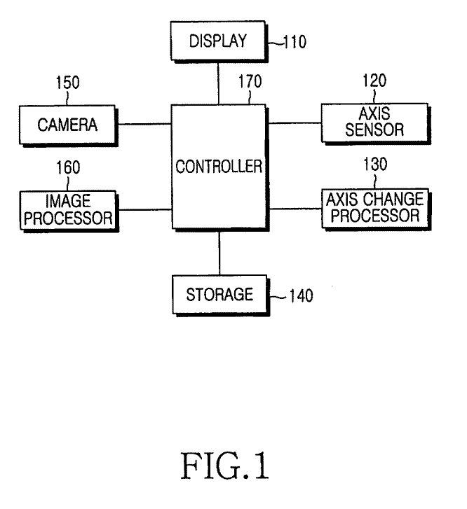

FIG. 1 is a block diagram illustrating the configuration of a mobile communication terminal for executing an application according to an embodiment of the present invention.

The mobile communication terminal for automatically executing an application in accordance with the change of an axis of a display includes a display 110, an axis sensor 120, an axis change processor 130, a storage unit 140, a camera 150, an image processor 160, and a controller 170.

The display 110 may be composed of an Liquid Crystal Display (LCD) and so on, and outputs various types of display data generated in the mobile communication terminal. In the case of implementing the display 110 as a touch screen type LCD, the display 110 may operate as an input means as well as an output means.

The axis sensor 120 senses the change of the axis of the display 110. The axis sensor 120 is mounted so that it can determine whether the display 110 is in a horizontal viewing position or in a vertical viewing position. The axis sensor 120 outputs the result of sensing the axis change to the axis change processor 130 through the controller 170. The axis sensor 120 may be constructed using an angular velocity sensor such as a gyroscope.

The storage unit 140 may be composed of a program memory and a data memory, and stores various kinds of information required for the operation of the mobile communication terminal. Particularly, in one embodiment of the present invention, the storage unit 140 stores data for executing an application installed in the mobile communication terminal. Also, the storage unit 140 stores information on which application is executed in accordance with a rotating direction when the display 110 of the mobile communication terminal is rotated into the horizontal viewing position.

The camera 150 captures an image. In one embodiment of the present invention, the camera 150 is mounted so that it can capture an image in a direction equal to a display direction of the display 110, and if the axis change of the display 110 is sensed by the axis sensor 120, the camera captures the image for face recognition.

The image processor 160 recognizes a face using existing face recognition technique by analyzing the image captured by the camera 150, and outputs the result of face recognition to the axis change processor 130 through the controller 170. The face recognition may be performed by existing face recognition methods using pattern recognition.

The axis change processor 130 operates to execute a preset application suitable to the horizontal viewing position in accordance with the sensing result from the axis sensor 120 and the result of face recognition from the image processor 160.

Specifically, the axis change processor 130 determines whether the display 110 is in the horizontal viewing position or in the vertical viewing position by analyzing the sensing result of axis change from the axis sensor 120. In this case, in order for the display 110 to determine whether the display 110 is in the horizontal viewing position or in the vertical viewing position, a proper error range may be set. For example, if the axis of the display is currently in an error range of 1-5 degrees in upward or downward direction based on a preset horizontal axis, it may be determined that the display is in the horizontal viewing position. Similarly, if the axis of the display is currently in an error range of 1-5 degrees in left or right direction based on a preset vertical axis, it may be determined that the display is in the vertical viewing position.

Also, if the display 110 is currently in the horizontal viewing position as the result of determination, the axis change processor 130 controls the camera 150 to capture an image, and outputs to the controller 170 a control signal, for controlling the image processor 160 to perform the image recognition with respect to the captured image. Then, if the result of face recognition is received from the image processor 160 and thus the face is recognized, the axis change processor 130 outputs a control signal for executing the preset application to the controller 170. For example, if the display 110 is rotated clockwise to be in the horizontal viewing position, the axis change processor 130 outputs a control signal for executing an application for Internet full browsing by using axis change sensed data from the axis sensor 120, but if the display 110 is rotated counterclockwise to be in the horizontal viewing mode, the axis change processor 130 outputs a control signal for executing an application for viewing digital broadcasts.

The controller 170 controls the operation of the mobile communication terminal according to an embodiment of the present invention. For example, if the control signal for executing the application for the Internet full browsing or the application for the digital broadcast viewing is received from the axis change processor 130 in accordance with the axis change, the controller 170 controls the mobile communication terminal to execute the corresponding application.

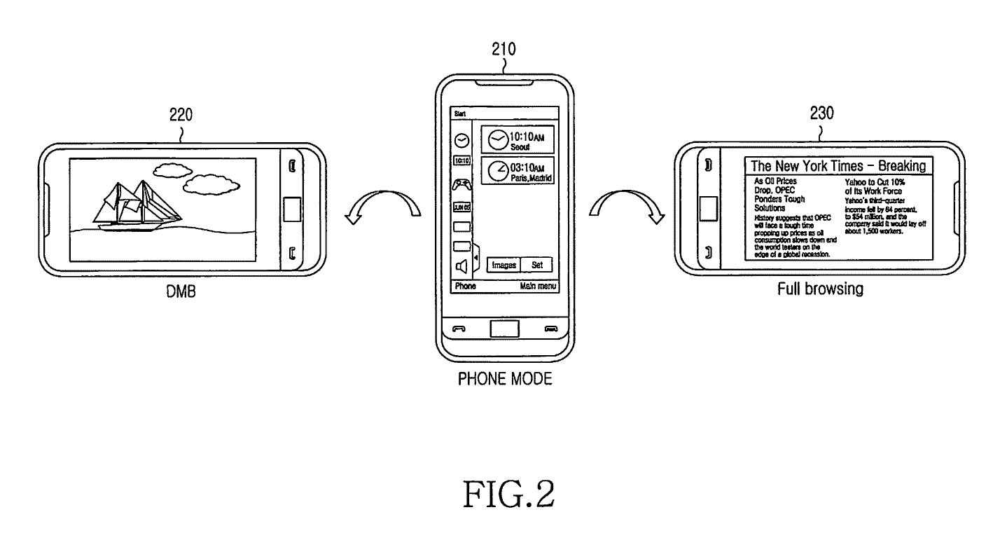

FIG. 2 is a diagram illustrating an application execution operation when a mobile communication terminal is shifted to a horizontal viewing position according to an embodiment of the present invention.

In FIG. 2, if the display 110, which is initially in the vertical viewing mode 210, is rotated clockwise and enters into the horizontal viewing position 230, the Internet full browsing application is executed, but if the display 110 is rotated counterclockwise and enters into the horizontal viewing position 220, the application for the digital broadcast viewing is executed.

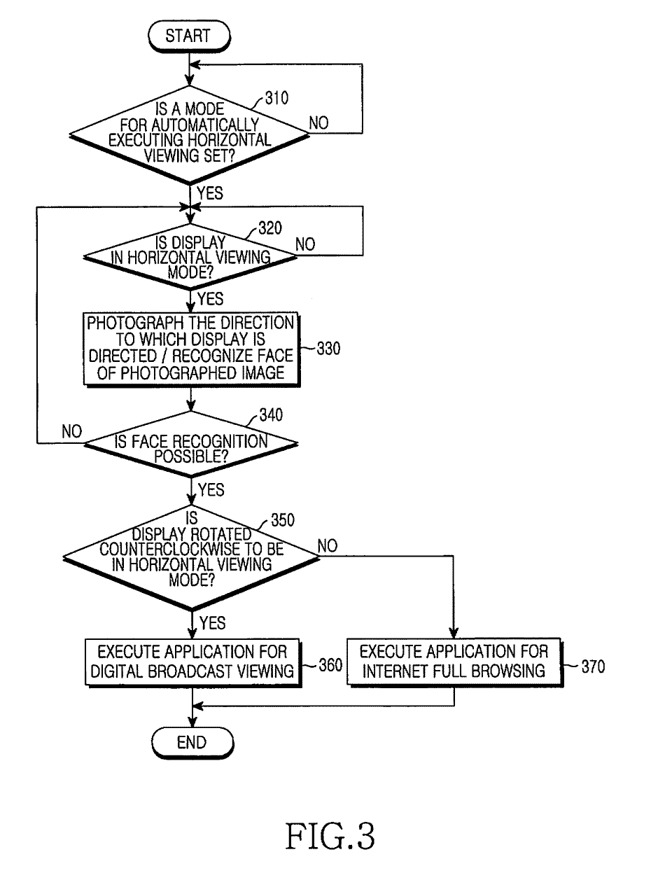

FIG. 3 is a flowchart explaining an application execution in a mobile communication terminal according to an embodiment of the present invention.

Referring to FIG. 3, it is determined whether a mode for automatically executing a horizontal viewing according to an embodiment of the present invention is set in the mobile communication terminal in step 310. The mode for automatically executing a horizontal viewing is a mode set to automatically execute a preset application (e.g. an Internet full browsing application or a digital broadcast viewing application) suitable to the horizontal viewing position when the display of the mobile communication terminal is rotated to be in the horizontal viewing position according to an embodiment of the present invention. If the mode for automatically executing the horizontal viewing is not set as the result of determination in the step 310, the controller enters into a standby state, but if the mode for automatically executing the horizontal viewing is set in the step 310, the process proceeds to step 320.

In the step 320, it is determined whether the display 110 is in the horizontal viewing position. This determination is made by sensing the axis change through the axis sensor 120 mounted on the display 110.

If the display 110 is not in the horizontal viewing position as the result of determination in the step 320, the controller enters into a standby state, but if the display 110 is in the horizontal viewing position, the process proceeds to step 330.

In the step 330, the photographing starts using the camera 150 attached to the front part of the mobile communication terminal, and the image processor 160 analyzes the photographed image to perform the face recognition.

Then, in step 340, it is determined whether the face recognition is possible as the result of face recognition through the image processor 160. This determination is to determine whether a user is looking at the display 110, and thus it is required to set the size of the face for recognition to be larger than a specified size. In addition, the face of the user of the mobile communication terminal may be preset, and it may be determined whether a face that is identical to the preset face is recognized in the step 340.

If the face is not recognized as the result of determination in the step 340, the controller proceeds to the step 320, but if the face is recognized, the process proceeds to step 350 and determines whether the display, which is currently in the horizontal viewing position, is rotated counterclockwise to be in the horizontal viewing position (corresponding to the first horizontal viewing position 220 in FIG. 2).

If the display 110 is rotated counterclockwise to be in the horizontal viewing position 220 as the result of determination in the step 350, the controller proceeds to step 360, and executes the application for the digital broadcast viewing.

If the display 110 is not rotated counterclockwise to be in the horizontal viewing position 220 as the result of determination in the step 350, the controller determines that the display 110 is rotated clockwise to be in the horizontal viewing position 230, proceeds to step 370, and executes the application for the Internet full browsing.

In addition, in order to terminate the application that is performed in the horizontal viewing position, the same key input method as the existing key input method may be used. In the case where the display is rotated to be in the vertical viewing position, it is possible to automatically terminate the application being performed. In this case, in the similar manner to the automatic application executing method in the horizontal viewing position as described above, it is sensed through the axis sensor that the display is rotated to be in the vertical viewing position, and if the face is not recognized from the image captured by the camera, the application in the horizontal viewing position is set to be terminated.

As described above, in the mobile communication terminal according to an embodiment of the present invention, the application executing method and apparatus can be configured and operated. Although the detailed embodiments of the present invention have been described, the applications executed in the steps 360 and 370 may be replaced by other applications (e.g. moving image reproduction, photographing, and the like) suitable to the horizontal viewing position in accordance with the characteristic of the terminal and the user's setting.

If the display of the mobile communication terminal according to the present invention is shifted to the horizontal viewing position, the application for the preset horizontal viewing position is automatically executed without any separate key input to heighten the user's convenience.

Also, only in the case where the user's face is recognized using the face recognition technique, the application is executed, and thus malfunction does not occur even in the case where the mobile communication terminal is unintentionally moved.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. A method of automatically executing an application in accordance with a rotation of a display in a mobile communication terminal, comprising the steps of:
sensing a rotation of the display by using an axis sensor;
taking a picture using a camera mounted in the mobile communication terminal if the display is in a first viewing mode as the result of the sensing;
performing a face recognition by analyzing an image of the picture; and
determining whether to execute an application in accordance with the result of face recognition.

2. The method as claimed in claim 1, wherein the camera takes a picture in a direction to which the display is directed.

3. The method as claimed in claim 2, wherein the first viewing mode is a horizontal viewing mode.

4. The method as claimed in claim 3, wherein the step of determining whether to execute the application in accordance with the result of face recognition comprises executing a preset application if the face recognition succeeds.

5. The method as claimed in claim 4, wherein in executing the preset application, if the display is rotated clockwise to be in the horizontal viewing mode, a first application is executed, and if the display is rotated counterclockwise to be in the horizontal viewing mode, a second preset application is executed.

6. The method as claimed in claim 5, wherein the first application is an application for viewing a digital broadcast and the second application is an application for Internet browsing.

7. The method as claimed in claim 4, further comprising terminating the application being executed if the display is shifted to a vertical viewing mode and the face is not recognized from the image captured by the camera during execution of the preset application.

8. The method as claimed in claim 1, wherein the axis sensor is an angular velocity sensor.

9. A mobile communication terminal for automatically executing an application in accordance with a rotation of a display, comprising:
a display for outputting various types of data generated in the mobile communication terminal;
an axis sensor to sense the rotation of the display;
a camera for capturing an image;
an image processor for performing a face recognition by analyzing image information captured by the camera; and
an axis change processor receiving the sensing result from the axis sensor, controlling the camera to take a picture if the display is in a first viewing mode, and determining whether to execute the application in accordance with the result of face recognition through the image processor.

10. The mobile communication terminal as claimed in claim 9, wherein the camera takes a picture in a direction to which the display is directed.

11. The mobile communication terminal as claimed in claim 10, wherein the first viewing mode is a horizontal viewing mode.

12. The mobile communication terminal as claimed in claim 11, wherein the determining of whether to execute the application in accordance with the result of face recognition through the axis change processor is the execution of a preset application if the face recognition succeeds.

13. The mobile communication terminal as claimed in claim 12, wherein in executing the preset application, if the display is rotated clockwise to be in the horizontal viewing mode, a first preset application is executed, and if the display is rotated counterclockwise to be in the horizontal viewing mode, a second preset application is executed.

14. The mobile communication terminal as claimed in claim 13, wherein the first application is an application for viewing a digital broadcast and the second application is an application for Internet browsing.

15. The mobile communication terminal as claimed in claim 12, wherein the axis change processor operates to terminate the application being executed if the display is shifted to a vertical viewing mode and the face is not recognized from the image captured by the camera during execution of the preset application.

16. The mobile communication terminal as claimed in claim 9, wherein the axis sensor is an angular velocity sensor.
